(19) United States
(12) Patent Application Publication
(10) Pub. No.: US 2026/0233939 A1
(43) Pub. Date: Aug. 13, 2026

(54) WORKSTATION FOR TRANSFERRING ITEMS BETWEEN LOAD CARRIERS

(71) Applicant: TGW Logistics GmbH, Marchtrenk (AT)

(72) Inventors: Sascha HROH, Brannenburg (DE); Florian FORSTER, Bad Endorf (DE); Simon WINHART, Bad Feilnbach (DE)

(73) Assignee: TGW Logistics GmbH, Marchtrenk (AT)

(21) Appl. No.: 19/155,638

(22) PCT Filed: Feb. 12, 2024
(86) PCT No.: PCT/AT2024/060045

§ 371 Date: Aug. 29, 2025

(30) Foreign Application Priority Data
Feb. 13, 2023 (AT) A50090/2023

(51) Int. Cl. B65G 1/137

(52) U.S. Cl. CPC B65G 1/1378; B65G 1/1371

(57) ABSTRACT

A workstation for transferring articles between load carriers, which are received in mobile transport loading aids, includes a control computer for acquiring transfer orders, a work zone and several provisioning positions for transport loading aids, wherein at least one delivery position is assigned to each provisioning position, and each provisioning position includes a lifting device for aligning load carriers with a delivery plane. The control computer is further configured to generate a transfer instruction. The workstation further includes a control device, which is configured to actuate the lifting devices such that the transport loading aids are aligned with the delivery plane according to the transfer instruction. Also, a picking system has several such workstations and a method transfers articles.

The invention relates to a workstation, in particular a picking station, for transferring articles between load carriers, which are received one above the other by mobile transport loading aids, according to the pre-characterizing portion of claims 1, 12, and to a picking system according to the pre-characterizing portion of claim 14. The invention further relates to a method for transferring articles, especially using such a workstation and/or such a picking system, according to claims 18, 25.

When an article is transferred, this is removed from a (first) load carrier provided at a first delivery position and transferred to one or more (further) load carriers provided at one or more further delivery positions. The article can comprise one or more pieces in this case.

Various devices and methods are known from the prior art, in which transferring is executed manually by a (picking) person or is automated, for example by a robot.

EP 2 607 271 A1 describes a method for article transfer and a workstation configured for this purpose with a work zone for a person, for example. A straight path extends in the work zone, along which the person can move back and forth between two provided load carriers filled with an article, remove an article from these and place this into further load carriers provided along the path.

JP 2018-070369 A2 discloses a workstation with a work platform for a picking person. In this case, load carriers are provided next to one another at an ergonomic height using a vertical portion of a conveying device, such that an article can be transferred from one of the load carriers to another load carrier provided adjacent.

US 2006/177290 A1 describes a workstation with a work zone, wherein load carriers are individually provided opposite one another.

The problem to be solved by the invention is to provide an improved workstation, an improved picking system and an improved method for transferring articles. In particular, the invention aims to enable particularly efficient processing of multiple transfer orders.

The problem is solved by a workstation for transferring articles between load carriers according to the features of claim 1.

The control computer is configured to generate a transfer instruction, which specifies an article type of an article to be transferred of at least one transfer order, a number of the articles to be transferred of this article type of the at least one transfer order, a load carrier containing the article to be transferred and the load carrier assigned to the at least one transfer order. The workstation further comprises a control device, which is configured to actuate the lifting devices such that those transport loading aids, from which the load carriers specified by the transfer instruction are received, are moved vertically so as to align the load carriers with the delivery plane.

However, the problem is also solved by a workstation for transferring articles between load carriers according to the features of claim 12.

The workstation for transferring articles between load carriers, which are arranged above one another to be received by mobile transport loading aids, comprises
a work zone delimited by a first and second vertical plane in a width direction, the vertical planes extending in the longitudinal direction,
a delivery plane intersecting the vertical planes, in which several delivery positions for load carriers are arranged adjoining the vertical planes and positioned at least partially in the work zone,
several provisioning positions for mobile transport loading aids, which are arranged next to one another on a side of the first and/or second vertical plane facing away from the work zone,
wherein at least one delivery position is assigned to each provisioning position, and each provisioning position comprises a lifting device for vertically moving the transport loading aid at the respective provisioning position in order to align load carriers with the delivery plane, such that the load carriers can be moved from the transport loading aids to the at least one delivery position assigned to the respective provisioning position,
wherein
each provisioning position comprises a lifting device arranged in a stationary manner for vertically moving the transport loading aid, wherein the stationary lifting device comprises a vertically extending support structure and a lifting platform adjustably mounted via a lifting drive thereon, wherein the transport loading aid can be placed on the lifting platform, and
the workstation additionally comprises a control device, which is configured to actuate the lifting platforms of the lifting devices such that the transport loading aids are individually moved vertically to such an extent that the load carriers, in particular with their respective base, are aligned with the delivery plane.

An advantage achieved with the invention can particularly be seen in that an article of the same article type, in particular one or more pieces (units) of this article, of different transfer orders, in particular picking orders, can be removed from a first load carrier and placed into one or more further load carriers assigned to the transfer orders. Several transfer orders can be executed essentially simultaneously and thus particularly efficiently in this way.

Transfer can be executed by a transfer operator, for example a (picking) person or a (picking) robot, which can move in the work zone of the workstation for this purpose.

The work zone can be any shape, the vertical planes being opposite one other such that load carriers can be provided at two (opposite) sides of the work zone.

In order to provide an equal distance between delivery positions arranged opposite one another and along the vertical planes and thus enable ergonomic transfers, it is preferably provided that the work zone has a base region with two parallel sides, for example a rectangular base region. It is expedient for the vertical planes to run parallel to one another and, in particular, to form the parallel sides of the base region.

However, the work zone can also be adapted to an available space and, for example, be configured to be L-shaped, wherein the vertical planes each comprise two portions which adjoin one another at a right angle, such that the vertical planes are also L-shaped.

Furthermore, the work zone can also be configured with a circular or oval base region. The vertical planes can extend in the longitudinal direction and each be curved about a vertical axis for this purpose. The work zone can thus be at least partially enclosed by the vertical planes and thereby delimited in a width direction.

Transfer orders typically comprise one or more order lines. Each order line has at least information about an article type and a number of an article of the article type. A first transfer order can comprise three order lines, for example two pieces of bananas, three pieces of salami and one apple.

The transfer orders can be (electronically) acquired, for example, using the control computer of the workstation. The transfer orders can respectively be assigned, in particular using the control computer, a load carrier, a receiving compartment or a load carrier insert, into which the article of the transfer order is to be placed.

The transfer orders can be picking orders, negative picking orders or replenishment orders, for example. A picking order is usually based on a customer order.

A negative picking order is also normally based on a customer order and specifies to a pre-picked load carrier which article contained is not required for the customer order and should therefore be removed therefrom. The pre-picked load carrier can contain three pieces of bananas, three pieces of salami and two apples, for example. A negative picking order can thus specify that one banana and one apple should be removed from the load carrier to complete the transfer order referenced by way of example above. The negative picking order can optionally also specify a (storage) load carrier, into which the removed article is to be placed.

It is also conceivable for a transfer order to comprise both an article to be removed from and article to be placed into a pre-picked load carrier. This can take place in two successive transfer steps, in particular according to two transfer instructions, for example.

A replenishment order usually specifies an article that is to be removed from a load carrier or from a pallet in order to fill a (storage) load carrier.

The transfer instruction can be based on one or more transfer orders and is generated by the control computer. Several customer orders can be processed essentially at the same time by transferring an article of the same article type of the different customer orders in one step, for example. For this purpose, the transfer instruction specifies the article type of the article to be transferred, a number of an article to be transferred, a first load carrier containing the article to be transferred, in particular in a number sufficient for the transfer instruction, at least one further load carrier assigned to the transfer order(s) and optionally, for each further load carrier, a number of an article to be transferred, which is to be placed into the respective further load carrier.

The load carriers are preferably configured to be stackable. Furthermore, the load carriers can have a single receiving compartment or several receiving compartments (arranged one behind the other) for receiving an article. In this case, provision can be made for several inserts (one behind the other) to be arranged in the single receiving compartment, or for one insert to be arranged in the receiving compartments respectively. The inserts can comprise trays, containers and/or bags, for example.

At least some of the load carriers are advantageously configured as, in particular stackable, boxes, preferably as plastic or wooden boxes. Alternatively or additionally, at least some of the load carriers can also be configured as cardboard boxes. The load carriers can optionally also be configured as stackable drawer boxers.

First load carriers of the load carriers can, for example, contain an article and be provided at the workstation, so that the article to be transferred can be removed therefrom. The first load carriers are preferably used for article storage in a warehouse or storage zone of a picking system and are referred to as warehouse load carriers, for example. It is expedient for the receiving compartment, the receiving compartments or the inserts of the first load carriers each to be filled with an article of the same article type.

Further load carriers of the load carriers can be provided at the workstation and filled with an article, preferably with an article of different article types, so that the article to be transferred can be placed into these. The further load carriers can be provided empty or already partially filled with an article of different article types, in particular pre-picked, for this purpose. The further load carriers are preferably used for article delivery to customers and are referred to as delivery load carriers, for example.

To transport several load carriers (simultaneously) to the work device, these are received by transport loading aids, which can be provided at the provisioning positions. The transport loading aids can comprise pallets, transport racks and/or support racks for this purpose.

The load carriers are received by the transport loading aids above one another, for example stacked or in shelf compartments of the transport loading aid arranged above one another. In addition, the load carriers can also be received next to one another by the transport loading aids. The load carriers can be received, for example, as stacks of load carriers arranged next to one another or in shelf compartments of the transport loading aid arranged next to one another for this purpose. Furthermore, the load carriers can also be received behind one another by the transport loading aids. The load carriers can be received, for example, as stacks of load carriers arranged behind one another or on storage spaces arranged behind one another in shelf compartments of the transport loading aid for this purpose.

A transport rack can comprise a transport frame, which forms several shelf compartments arranged above one another and/or next to one another for receiving load carriers. The shelf compartments are preferably accessible from a first and/or second access side. Such a transport frame is described, for example, in WO 2022/082249 A2, which is incorporated in its entirety in this application.

A support rack can further comprise a transport frame with several uprights and preferably a base supported by the transport frame. Such a transport loading aid is described, for example, in WO 2021/142498 A1, which is incorporated in its entirety in this application. The load carriers can be received, in particular stacked, on the transport frame or on the base.

A loading platform of a driverless transport vehicle, for example, can contact the transport frame of the support rack or of the transport rack so as to transport the support rack or the transport rack.

The load carriers, in particular cardboard boxes, can be received stacked on a pallet. If necessary, the pallet can be positioned on a support rack for transport with a driverless transport vehicle.

The (mobile) transport loading aids are preferably configured to be able to be transported by a transport system.

For this purpose, the transport system can comprise a stationary conveying system and/or a mobile conveying system, for example. The transport system, in particular the mobile conveying system, particularly preferably comprises a plurality of driverless transport vehicles, which can be controlled, for example, by a superordinate master computer. Such transport vehicles are known to the skilled person by the terms “automated guided vehicles” (abbreviated to “AGV”) or “autonomous mobile robots” (abbreviated to “AMR”).

The transport loading aids can be transported by the transport system to the provisioning positions, provided at these and/or passed to a lifting device arranged there, in particular in a stationary manner.

The lifting device, which is in particular arranged in a stationary manner, is configured to lift and/or lower transport loading aids.

The lifting devices can align precisely those load carriers required to fulfill the transfer order, in particular their lower edge, with the delivery plane. Picking errors can be reliably avoided and the load carriers be supplied at an ergonomic working height in this way.

Each of the lifting devices can comprise at least one vertically movable lifting platform, on which the transport loading aids can be placed for this purpose. In this case, a transport loading aid can be placed onto the lifting platform, for example, by the transport system, in particular by a transport vehicle. Alternatively, the transport vehicle can be parked on the lifting platform with the respective transport loading aid.

The lifting platforms of the lifting devices are preferably (continuously) adjustable between a lower position and an upper position. In the lower position, an uppermost load carrier, received by the transport loading aid, of the load carriers arranged one above another, is aligned with the delivery plane, in particular with its lower edge. Furthermore, in the upper position, a lowermost load carrier, received by the transport loading aid, of the load carriers arranged one above another, is aligned with the delivery plane, in particular with its lower edge.

In order to provide the load carriers on both sides of the work zone at the same (ergonomic) working height, the delivery plane is preferably horizontally aligned.

In addition, the delivery positions are arranged in the delivery plane, which are, at least partially, in particular positioned in the work zone. The delivery positions preferably adjoin a side of the respective vertical plane facing the work zone for this purpose.

Load carriers can be provided at the delivery positions for removing and/or placing an article. The load carriers can be moved manually or, as described below, automatically from the transport loading aids to the delivery position, for example pulled or pushed.

It is favorable for the workstation to comprise a first and second side wall, wherein a side of the first side wall directed toward the work zone lies in the first vertical plane and a side of the second side wall directed toward the work zone lies in the second vertical plane, such that the work zone is delimited by the side walls in a width direction. The side walls provide a physical barrier between the work zone and the provisioning positions, thereby increasing worker safety in the work zone. The side walls can be configured in particular as a wall or as a safety grid for this purpose.

In order to enable a movement of load carriers between transport loading aids and the delivery positions, it is preferably provided that the side walls each have at least one delivery opening extending in the longitudinal direction over one or more delivery positions, such that each delivery position is assigned a delivery opening.

The delivery openings can extend, in particular in the longitudinal direction, over all delivery locations of the respective side wall, such that the same delivery opening is assigned to each delivery position along the respective side wall. A delivery opening is preferably provided for each provisioning position, the former extending over the delivery positions assigned to the respective provisioning position. It can also be provided that several delivery openings are arranged next to one another along the side walls, which extend in the longitudinal direction over exactly one delivery position respectively. Each delivery position is thus assigned a delivery opening. In a simpler configuration without a delivery opening, it can be provided that an upper edge of the side walls extends in the delivery plane.

It is advantageous for the delivery openings to each have a door, which, in particular, can be opened automatically. By doing so, delivery openings not in use can be closed, for example during a load carrier change or lifting and/or lowering transport loading aids, thus additionally increasing occupational safety.

In this case, it is preferably provided that the control device is configured to actuate the doors such that (only) those delivery openings are opened, at which the load carriers specified by the transfer instruction are arranged.

For removing the article from the first load carrier and placing the article into the further load carrier(s), the load carriers specified by the transfer instruction can be moved from the respective transport loading aid to a delivery position. This can be executed manually by a person pulling the corresponding load carriers from the transport loading aid, in particular through the delivery opening, to the delivery position positioned in front of the load carrier. After the article has been removed or placed, the person can push the load carriers back into or onto the transport loading aid.

Alternatively, this can also be done automatically. It is preferably provided that a delivery device for moving a load carrier, in particular for individually moving several load carriers arranged next to one another, from the respective transport loading aid to a delivery position, is arranged at each of the provisioning positions for this purpose.

In this case, it is favorable for the control device to be configured to actuate the delivery devices such that the load carriers specified by the transfer instruction are moved from the respective transport loading aid to the delivery position. It is further expedient for the control device to be configured to actuate the delivery devices such that the load carriers specified by the transfer instruction, in particular after an article has been removed and/or placed, are moved from the respective transport loading aid to the delivery position.

The delivery device advantageously comprises a push-out device, which is configured to push a load carrier or several load carriers arranged next to one another from the transport loading aid, in particular through the delivery opening, to one of the delivery positions. The push-out device can have one or more horizontally movable pushing elements for this purpose.

In addition, the delivery device can comprise a pull device, which is configured to pull back a load carrier or several load carriers arranged next to one another from the respective delivery position into or onto the transport loading aid. The pull device can have one or more horizontally movable pull elements for this purpose.

In order to support the load carriers at the delivery positions from below, provision is preferably made for one or more work surfaces to be arranged respectively along the first vertical plane and/or along the second vertical plane, wherein the work surfaces lie in the delivery plane and have the delivery positions arranged on the delivery plane. The work surface(s) can each be provided by a horizontal plate arranged on the respective side wall, for example.

It is preferably provided that a work platform, in particular a raised, walkable work platform, is arranged in the work zone, wherein a vertical distance between the work platform and the delivery plane can preferably be changed. By doing so, a higher working position and thus a particularly ergonomic working height can be achieved, at which the load carriers are supplied. Due to the changeable vertical distance, the workstation can be adjusted to a worker's physical height. For this purpose, the work platform can be mounted such that it can be moved vertically, for example.

To automate transfers, it can be provided that a robot, in particular a picking robot, which can be moved along the longitudinal direction, for transferring an article between load carriers provided at the delivery positions, is arranged in the work zone. The robot can be configured as an articulated-arm robot or portal robot that can be moved in the work zone, in particular along the longitudinal direction, each having a gripping unit for removing an article, for example.

It is expedient for the workstation to comprise at least one input/output unit, preferably connected to the control computer and/or the control device, which is configured to display the number of an article to be transferred specified by the transfer instruction and/or to display a number of an article and to be placed into the load carriers assigned to the at least one transfer order, and/or to receive a confirmation command for the load carriers.

It is advantageous for an input/output unit to be arranged at each delivery position, so that a number of an article to be removed from or placed into the load carrier provided at the delivery position can be displayed at each delivery position. The input/output unit can also optionally display the receiving compartment or insert of the load carrier from which the article is to be removed or the receiving compartment or insert of the load carrier into which the article is to be placed. Furthermore, any article removal from a load carrier and/or any article placement into a load carrier can be directly confirmed thus.

The input/output unit preferably has a screen, in particular a touch screen, by means of which data pertaining to the transfer instruction can be displayed, for example a number of an article to be removed or placed, an image of the article, a receiving compartment, and the like.

The input/output unit can comprise an input element for receiving the confirmation command, for example a button, a foot switch, a touch pad on a touch screen, a switch or the like. The confirmation command can be used to confirm placement and/or removal of an article, i.e. the successful placement or removal can be confirmed. The respective load carrier can be moved from the delivery position back to the transport loading aid as a result of the input/output unit receiving the confirmation command, and the next load carrier can be provided for the next transfer instruction.

The input/output unit can optionally comprise a scanning unit for scanning an article upon removal from a load carrier or upon placement into a load carrier. The scanning unit can be configured as a barcode scanner, RFID scanner or QR code scanner, for example.

It is also favorable for the workstation to comprise one or more transport loading aids and/or several load carriers.

It also proves advantageous for each provisioning position to comprise a lifting device arranged to be stationary for vertically moving the transport loading aid.

Each lifting device can comprise a vertically extending support structure and a lifting platform adjustably mounted on the lifting platform via a lifting drive for this purpose.

The transport loading aid, from which the load carriers specified by the transfer instruction is/are received, can be moved or placed onto the lifting platform. This can be a first load carrier, which contains the article to be transferred, or a further load carrier, which is assigned to the at least one transfer order, in particular which is filled with the article. However, this can also be a first load carrier, which contains the article to be transferred, and a further load carrier, which is assigned to the at least one transfer order, in particular which is filled with the article.

The lifting drive of the lifting devices is connected to the control device, which in turn actuates the lifting devices such that those transport loading aids, from which the load carriers specified by the transfer instruction are received, in particular one or more first load carriers and/or one or more further load carriers, are moved vertically so as to align the load carriers, in particular with their base, with the delivery plane.

On the one hand, one of the (stationary) lifting devices can be provided for the transport loading aid to be placed on the lifting platform, from which the first load carriers specified by the transfer instruction is/(are) received, which contain(s), for example, an article of a first order, for example bananas.

On the other hand, one of the (stationary) lifting devices can be provided for the transport loading aid to be placed on the lifting platform, from which the first load carriers specified by the transfer instruction is/(are) received, which contain(s), for example, an article of a second order, for example apples.

The lifting devices can be arranged on a side of the first vertical plane facing away from the work zone and next to one another.

On the one hand, one of the (stationary) lifting devices can be provided for the transport loading aid to be placed on the lifting platform, from which the further load carriers specified by the transfer instruction are received, which is/(are) filled with an article of a first order, for example.

On the other hand, one of the (stationary) lifting devices can be provided for the transport loading aid to be placed on the lifting platform, from which the further load carrier(s) specified by the transfer instruction are received, which is/(are) filled with an article of a second order, for example.

The lifting devices can be arranged on a side of the second vertical plane facing away from the work zone and next to one another.

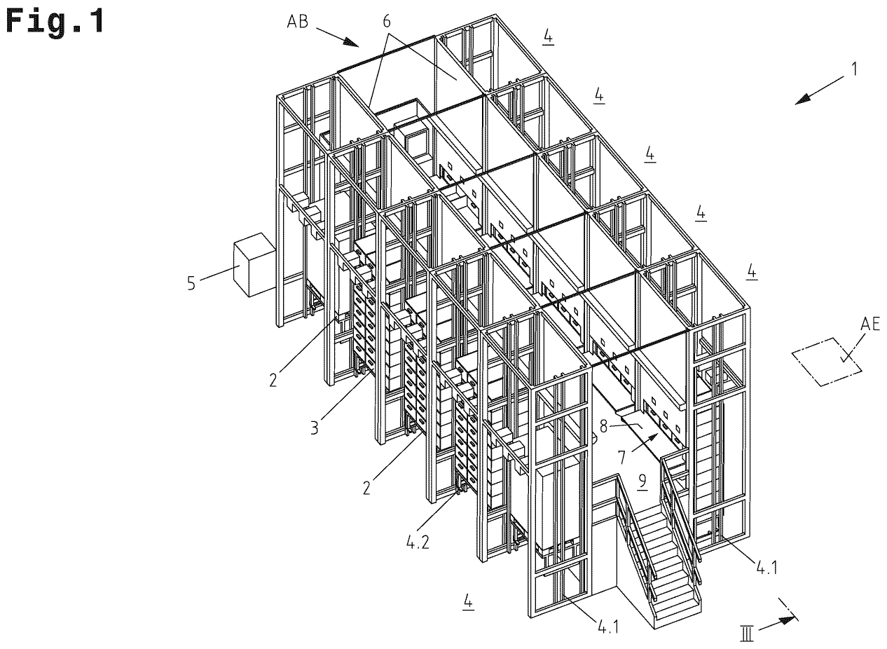

It should also be noted that the lifting devices, which are arranged next to one another on a side of the first vertical plane facing away from the work zone, and the lifting devices, which are arranged next to one another on a side of the second vertical plane facing away from the work zone, can be arranged on both sides of the work zone, as shown in FIG. 1, for example.

By utilizing the aforementioned advantages and effects, the problem is further solved by the type of picking system mentioned at the beginning, the workstation being configured according to one of the aspects previously described.

The workstation essentially provides a picking station of the picking system in this case. The transfer orders preferably include picking orders, which are assigned to customer orders in particular.

The picking system comprises a transport system for transporting the transport loading aids. In this case, the transport system can be configured as described above.

The transport system particularly preferably comprises a plurality of driverless transport vehicles. Thus, the transport loading aids can be moved individually in the picking system. Furthermore, the use of transport vehicles enables fast installation of the picking system without the complex set up of a stationary conveying system. Thus, the picking system can be installed in existing buildings, for example in disused shops.

For article storage in the storage zone, it is preferably provided that several load carriers, in particular first load carriers, with an article of different article types, are received by some of the transport loading aids respectively. The load carriers preferably each have at least one receiving compartment, which is filled with an article of a single type. In this case, the load carriers can be formed with a single receiving compartment or with several receiving compartments, as described above.

It is advantageously provided that the picking system further comprises a warehouse management system and a transport system control unit.

In this case, the warehouse management system is preferably configured to acquire several transfer orders for a defined time window and to generate a transport order based on the acquired transfer orders, the transport order indicating the transport loading aids required for the transfer orders and the provisioning positions of the at least one workstation assigned to the transport loading aids.

The transport system control unit is further preferably configured to receive the transport order from the warehouse management system and to actuate the transport system such that transport loading aids are transported from the storage zone to the assigned provisioning position in accordance with the transport order.

The problem is further solved by utilizing the advantages and effects described above by a method according to claim 18, which comprises the following steps:
i) acquiring transfer orders using the control computer of the workstation, the transfer orders each comprising a number of an article,
ii) providing transport loading aids with load carriers, which contain the article of the transfer orders, and transport loading aids with load carriers, which are respectively assigned to at least one transfer order by the control computer,
iii) generating a transfer instruction using the control computer, which specifies an article of the same article type to be transferred of at least one transfer order, a first load carrier containing the article to be transferred and at least one further load carrier assigned to the at least one transfer order,
iv) aligning the first and the at least one further load carrier with the delivery plane using the lifting devices,
v) providing load carriers, the first load carrier specified by the transfer instruction and at least one further load carrier specified by the transfer instruction being moved from the transport loading aid to the respectively assigned delivery position,
vi) transferring an article according to the transfer instruction, the article to be transferred being removed, in particular by a transfer operator, preferably at the number specified in the transfer instruction, from the first load carrier at the respective delivery position and, in particular several pieces of the article successively, being placed into the at least one further load carrier,
vii) generating a further transfer instruction using the control computer, which specifies an article of the same article type to be transferred of at least one transfer order, a first load carrier containing the article to be transferred and at least one further load carrier assigned to the at least one transfer order,
viii) repeating the steps iv) to vi) for the further transfer instruction.

An advantage achieved with the invention, as described above, can particularly be seen in that an article of the same article type and of different transfer orders can be removed substantially simultaneously from the first load carrier and placed into one or successively into more further load carriers. Several transfer orders, for example picking orders, can be executed essentially simultaneously and thus particularly efficiently in this way.

The method is advantageously executed using a workstation described above and/or using a picking system described above.

The load carriers containing the articles provided in the step ii) can be, for example, load carriers used to store articles, or load carriers that have already been pre-picked, from which negative picking is to be executed. “Negative picking” is understood as the removal of an article not required for an order from a pre-picked load carrier.

Furthermore, the load carriers provided in the step ii), which are each assigned to at least one transfer order by the control computer, can be load carriers used for article delivery to customers. Alternatively, these can be load carriers used for article storage. In this case, an article can be negatively picked from pre-picked load carriers or unloaded from pallets, for example, and delivered to a load carrier for storing the article.

It is favorable for one of the further load carriers in the step iii), into which an article is or is to be placed last in the step vi), to be defined as the last load carrier. By doing so, it is possible to define exactly that load carrier at which the transfer instruction ends, and thus also to define a position at which the transfer operator comes to a standstill in the step vi) after the transfer has taken place. This can be used in particular for generating the further transfer instruction.

It is further advantageous for the transfer instruction generated in the step iii) to comprise a sequence direction, along which the further load carriers are arranged, wherein the further load carrier arranged last in the sequence direction is determined as the last load carrier and in the step vi), for the article, in particular several pieces of the article, to be placed successively into the further load carriers provided along the sequence direction, wherein an article is delivered last into the last load carrier. A sequence can thus be specified, in which the article, in particular pieces of the article, are to be placed into the load carriers, resulting in the optimization of a path covered by the transfer operator during the transfer. On the one hand, this achieves a particularly ergonomic work flow when the transfer is executed thus by a person. On the other hand, energy consumption can be reduced when the transfer is executed by a robot.

It is preferably provided that the longitudinal direction extends between two ends of the workstation and the sequence direction extends from the end closer to the delivery position assigned to the first load carrier to the end farther away from the delivery position assigned to the first load carrier.

To further minimize the distance covered during transfer, it is preferably provided that the further transfer instruction in the step vii) is generated such that this comprises that article of the same article type that is contained in a load carrier provided at a provisioning position opposite the last load carrier of the (preceding) transfer instruction, in particular its delivery position.

If the delivery openings each have a door that can be automatically opened as described above, it is expedient for (only) the doors of those delivery openings, with which the load carriers specified by the transfer instruction are aligned, to be opened in the step v).

It is advantageously provided that a delivery device for moving a load carrier, in particular for individually moving several load carriers arranged next to one another, from a transport loading aid to a delivery position, to be arranged at each of the provisioning positions, and that the load carriers specified by the transfer instruction are moved from the transport loading aid to a delivery position by the respective delivery devices in the step v).

It is advantageously provided that the transport loading aids are stored in a storage zone, in particular in a storage zone of a picking system previously described, and in the step ii), are transported from the storage zone to the workstation by a transport system, in particular by driverless transport vehicles. This can be executed preferably in accordance with a transport order previously described.

In order to replenish a stock, it can be provided that an article is removed from load carriers arranged on pallets and placed into storage load carriers provided, for example. In this case, it can be advantageous for the at least one transfer order of the transfer instruction (respectively) to be a replenishment order, the first load carrier being completely emptied and the at least one further load carrier being filled with the article to be transferred (of a single type) in the step vi).

In addition, it can be provided that the at least one transfer order of the transfer instruction is, in particular based on a customer order, a picking order, which comprises one or more order lines, wherein each order line comprises at least information on an article type and a number of the articles of this article type.

Furthermore, it is preferably provided that, in the step ii), some pre-picked load carriers are provided as first load carriers and load carriers that are empty or filled with an article are provided as further load carriers, and at least one transfer order, in particular several or all transfer orders, is a negative picking order, which specifies a number of articles per article type to be removed from the pre-picked load carrier, articles being removed from the first load carriers in accordance with the at least one negative picking order in the step vi).

The problem is further solved in that the advantages and effects described above are utilized by a method for transferring articles between load carriers according to claim 25, comprising the steps:
i) acquiring transfer orders by a control computer, the transfer orders each comprising a number of articles,
ii) providing mobile transport loading aids comprising a mobile first transport loading aid with first load carriers, which contain the article of the transfer orders, and a mobile second transport loading aid with further load carriers, which are respectively assigned to at least one transfer order by the control computer,
iii) generating a transfer instruction by the control computer, which specifies an article to be transferred of at least one transfer order, a first load carrier containing the article to be transferred and/or one further load carrier assigned to the at least one transfer order,
iv) receiving the mobile first transport loading aid with the first load carriers on a first lifting device of the lifting devices, and receiving the mobile second transport loading aid with the further load carriers on a second lifting device of the lifting devices,
v) aligning the first load carrier by vertically moving the mobile first transport loading aid using the lifting platform of the first lifting device, and aligning the further load carrier by vertically moving the mobile second transport loading aid using the lifting platform of the second lifting device, in each case with the operation plane (therefore aligning the first load carrier and aligning the further load carrier with the delivery plane respectively),
vi) providing the first load carrier by moving the first load carrier aligned with the operation plane to the assigned (first) delivery position, and providing the further load carrier by moving the further load carrier aligned with the operation plane to the assigned (second) operation position,
vi) transferring an article according to a transfer instruction, the article to be transferred being removed from the first load carrier provided at the (first) operation position and, in particular successively, being placed into the further load carrier provided at the (second) delivery position.

The figures below elaborate on the invention to offer better understanding thereof.

Each shows in greatly simplified, schematic depiction:

FIG. 1 a perspective view of a workstation,

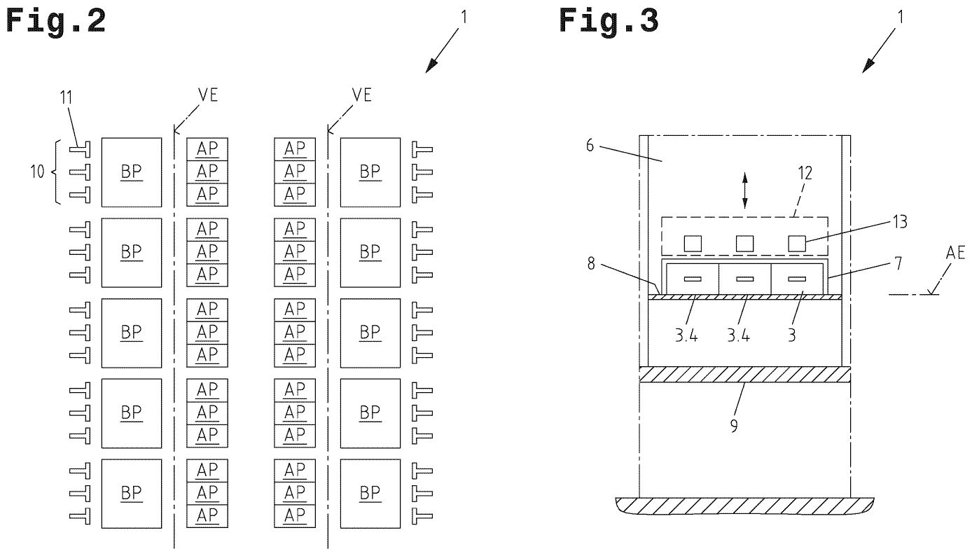

FIG. 2 a plan view of the workstation,

FIG. 3 a cross-sectional representation of the workstation,

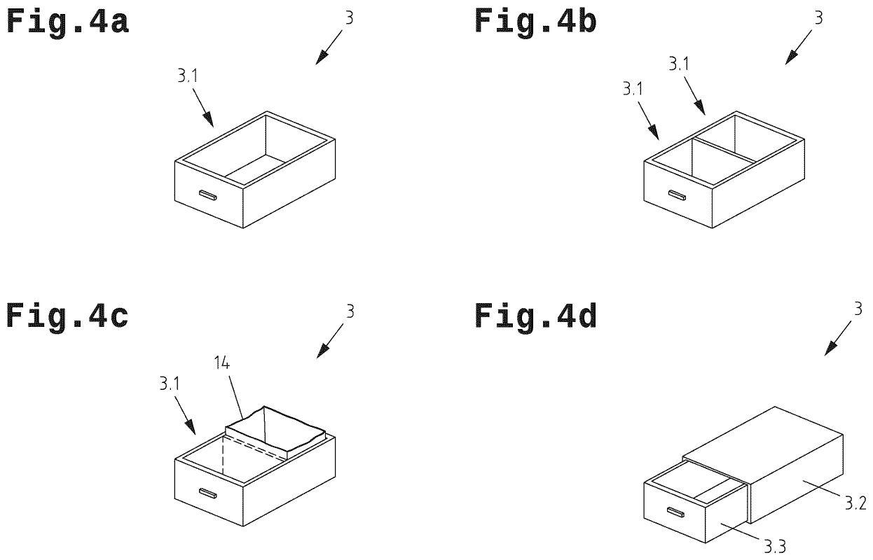

FIGS. 4a to 4c a perspective view of a loading aid respectively,

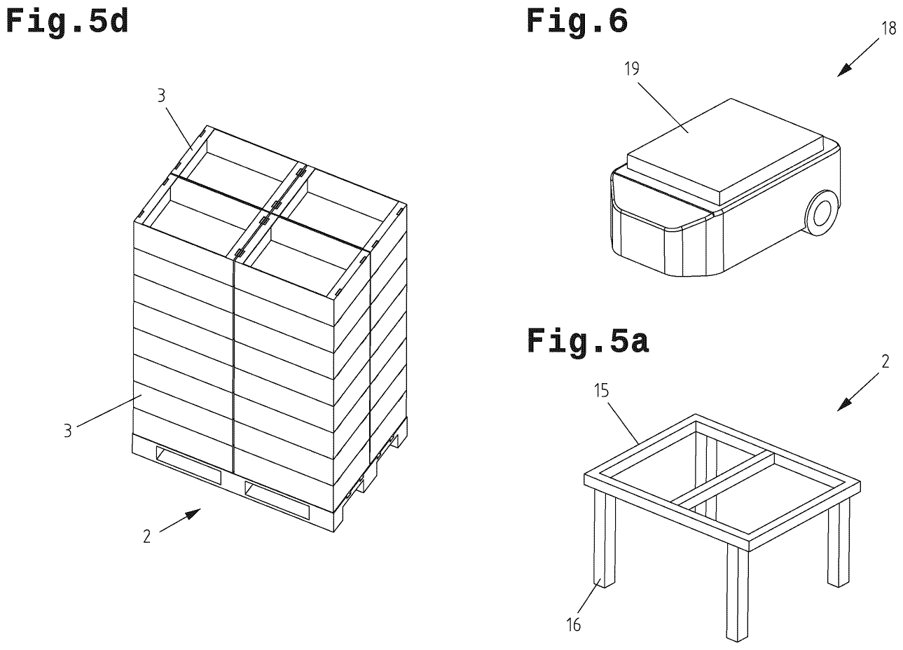

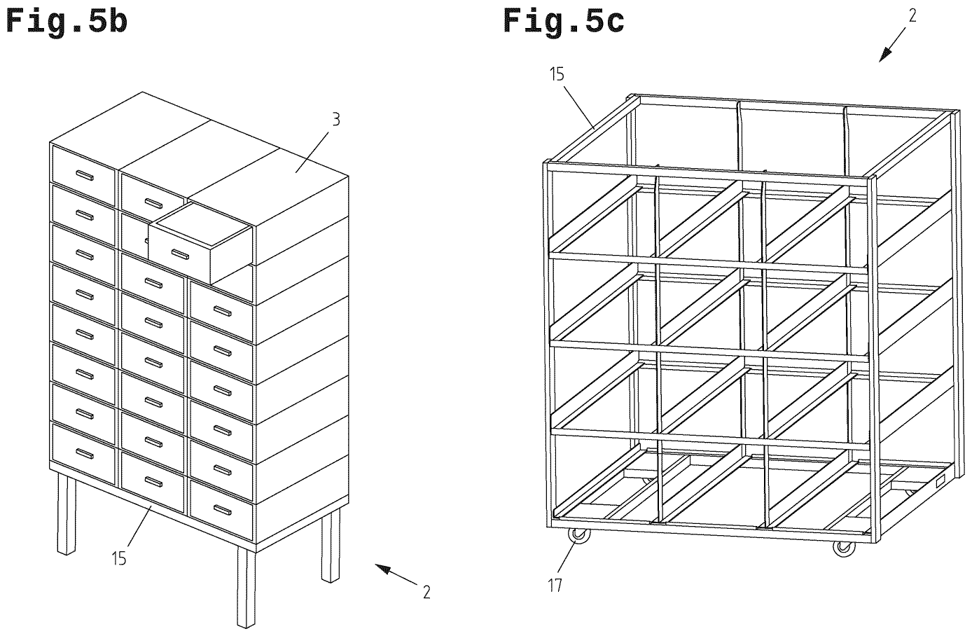

FIGS. 5a to 5d a perspective view of a transport loading aid respectively,

FIG. 6 a perspective view of a transport vehicle,

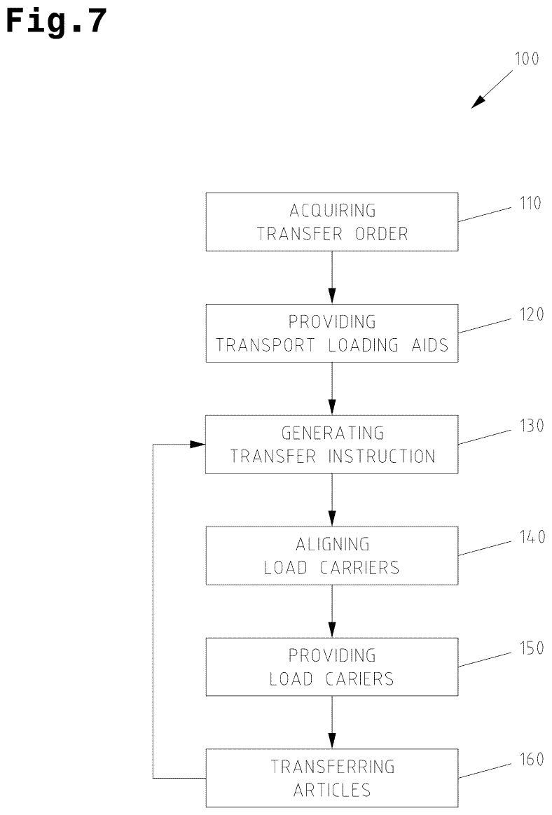

FIG. 7 a method for transferring an article,

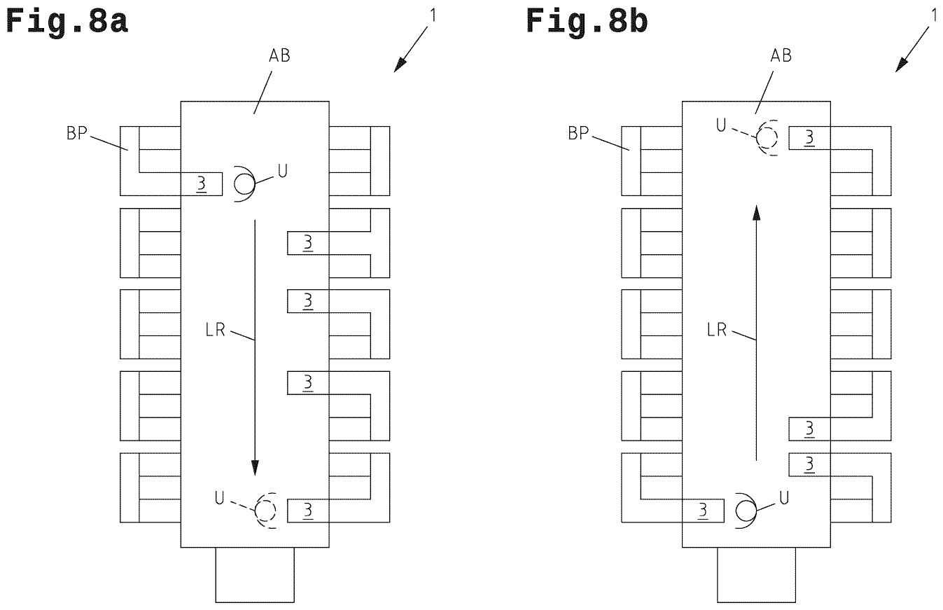

FIGS. 8a and 8b transferring an article,

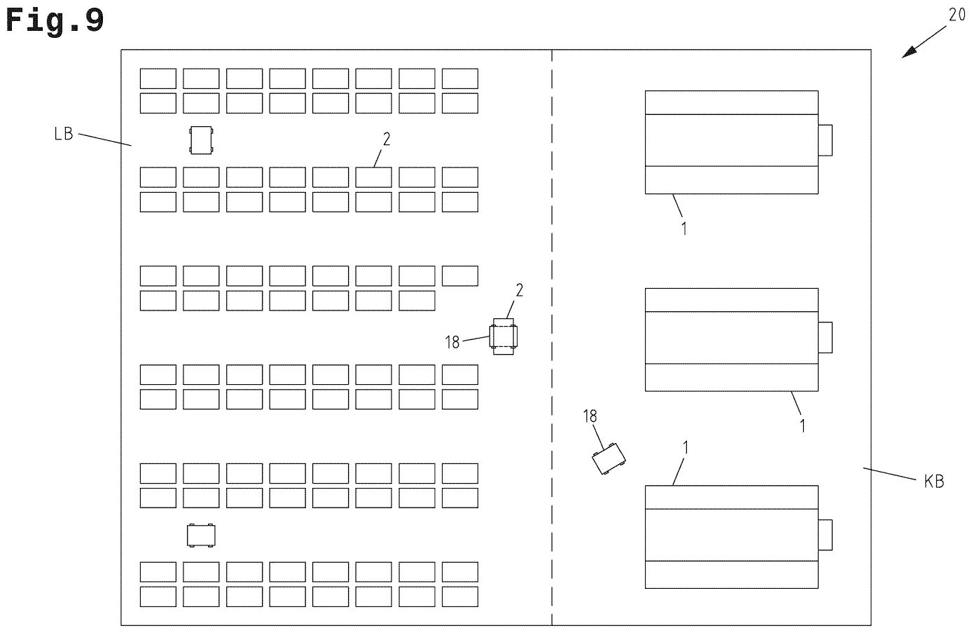

FIG. 9 a picking system with several workstations.

It is worth noting here that the same parts have been given the same reference numerals or same component designations in the embodiments described differently, yet the disclosures contained throughout the entire description can be applied analogously to the same parts with the same reference numerals or the same component designations. The indications of position selected in the description, such as above, below, on the side etc. also refer to the figure directly described and shown, and these indications of position can be applied in the same way to the new position should the position change.

FIG. 1 shows a perspective view of a workstation 1. The workstation 1 is also depicted in plan view in FIG. 2.

The workstation 1 comprises a work zone AB, in which a transfer operator U, for example a picking person or a picking robot for transferring an article, can move back and forth. The work zone AB is delimited in a width direction by two vertical planes VE opposite one another. Furthermore, the workstation 1 comprises an imagined (horizontal) delivery plane AE, which intersects the two vertical planes VE at a working height.

Several delivery positions AP drawn in FIG. 2 are arranged in the delivery plane AE, the former being positioned at least partially in the work zone AB and at which load carriers 3 can be provided. Furthermore, several provisioning positions BP arranged next to one another are provided on sides of the vertical planes VE facing away from the work zone AB.

Transport loading aids 2 can be provided at the provisioning positions BP as shown in FIG. 1. A plurality of load carriers 3 arranged above one another are received by the transport loading aids 2 in this case.

The provisioning positions BP each comprise a lifting device 4 for lifting and/or lowering transport aids 2. The lifting devices 4 are arranged in a stationary manner and each comprise a vertically extending support structure 4.1 and a lifting platform 4.2. adjustably mounted on the lifting platform via a lifting drive. The lifting devices 4 preferably each comprise lifting elements that can be moved vertically on a support structure. In addition, the workstation 1 comprises a control system 5, which has a control device for actuating the lifting devices 4 so as to align load carriers 3 with the delivery plane AE on the one hand. The control system 5 has a control computer for acquiring transfer orders and generating transfer instructions on the other hand.

To delimit the work zone AB, the workstation 1 can comprise two side walls 6 opposite one another, each of which is aligned with one of the vertical planes VE.

The side walls 6 can further have one or more delivery openings 7 aligned with the delivery positions AP, such that load carriers 3 can be moved through the respective delivery opening 7 from the transport loading aid 2 to the delivery position AP.

The work device can further comprise several, in particular horizontally aligned, storage platforms, which provide the work surface(s) 8. The storage platforms can be positioned such that the work surfaces 8 are in the delivery plane AE and the delivery positions AP are on the work surface(s) 8 in this case. The platforms are preferably mounted on a side facing the work zone on the side walls 6. The platforms can optionally also be configured in an inclined manner to allow better access to the interior of the load carriers 3.

A work platform 9 can be arranged in the work zone AB, the former preferably being spaced from a base such that the delivery plane AE is aligned at an ergonomic height. The workstation 1 can comprise a staircase or ladder, for example, via which the work platform 9 can be reached.

A delivery device 10 can be provided at the provisioning positions BP respectively to move the load carriers 3 from the transport loading aid 2 to the delivery positions AP. The delivery device 10 preferably has a push-out device with several push elements 11 and/or a pull device with several pull elements, by means of which load carriers 3 arranged next to one another can be pushed onto the delivery positions AP and/or pulled back from the delivery positions AP onto the transport loading aid 2. For the sake of clarity, the delivery device 10 is not shown in FIG. 1.

FIG. 3 shows a section of the workstation 1 in cross-sectional representation along the line III indicated in FIG. 1. The delivery openings 7 are arranged at a vertical distance above the work platform 9. A lower edge of the delivery openings (7) is in the delivery plane AE. The delivery openings 7 are preferably height adapted to a height of the load carriers 3 and are at least wide enough to allow one or more load carriers 3 next to one another to be moved through these.

In order to close the delivery openings 7, these can each have an optional door 12, which is shown by dashed lines in FIG. 3. The door 12 can be configured, for example, as a sliding door that can be moved orthogonally to the delivery plane AE and/or vertically, as indicated by a double arrow in FIG. 3.

Furthermore, each provisioning position BP or, as shown in FIG. 3, each delivery position AP can be assigned an input/output unit 13, which is connected to the control system 5 and is configured to display information pertaining to the transfer instruction and/or to receive a confirmation command.

The load carriers 3, in particular with their respective base 3.4, are aligned with the delivery plane AE, as shown in FIG. 3.

Exemplary load carriers 3 are depicted in FIG. 4a to FIG. 4d, which comprise at least one receiving compartment 3.1 respectively for receiving an article. Each of the load carriers 3 also comprises a base 3.4.

As shown in FIG. 4a, for example, the load carrier 3 can have a single receiving compartment 3.1 or, as shown in FIG. 4b, several receiving compartments 3.1, preferably arranged one behind the other for receiving an article. The receiving compartments 3.1 can be separated from one another by one or more optional partitioning walls, for example.

It can additionally be provided that, in particular as shown in FIG. 4c, one or more inserts are received in the single receiving compartment 3.1, or one insert for receiving an article, for example a bag 14, is received in each of the several receiving compartments 3.1 of the load carrier 3. The optional partitioning wall is represented by dashed lines in FIG. 4c.

In order to ensure access to the interior of the load carrier 3 even when several load carriers 3 are stacked above one another, the load carrier 3 can be configured as a drawer box, as shown in FIG. 4d, for example. In this case, the load carrier 3 comprises an outer part 3.2 and an inner part 3.3, which is mounted such that it can be pushed out in the outer part 3.2, wherein an interior of the load carrier 3 is accessible by a relative push-out movement between the inner part 3.3 and the outer part 3.2. According to this embodiment, the outer part 3.2 comprises the base 3.4. In this case, it can be provided that the inner part 3.3 can be moved out of the outer part 3.2 by pulling on a first access side and/or by pushing from a second access side. The inner part 3.3 can be configured as described above in relation to FIG. 4a to FIG. 4c in this case. A load carrier 3 configured as a drawer box is known from EP 3 423 365 B1, for example, and is described therein as a “container”.

The receiving compartment 3.1, the receiving compartments 3.1 and/or the inserts can each be filled with an article of the same article type, for example for storing an article, in particular if the respective load carrier 3 is used as the first load carrier 3. It can alternatively be provided that the receiving compartment 3.1, the receiving compartments 3.1 and/or the inserts are each filled with an article of different article types. This is particularly advantageous if an article in such a load carrier 3 is combined in accordance with a transfer order, for example a picking order, and/or the load carrier 3 is used as a further load carrier 3, in particular as a delivery load carrier 3. For this purpose, the transfer instruction can also comprise a number of articles to be placed into the respective receiving compartment 3.1 and/or into the respective insert for each receiving compartment 3.1 or for each insert of the at least one further load carrier 3.

FIG. 5a shows a transport loading aid 2, which comprises a transport frame 15 with several uprights 16. As shown in FIG. 5b, several load carriers 3 can be arranged above one another and/or next to one another on the transport frame 15 and can thus be received by the transport loading aid 2. The transport loading aid 2 can optionally comprise a loading base—not shown in FIG. 5b-supported by the transport frame 15, the load carriers 3 being able to be stacked on said loading base.

FIG. 5c shows a transport loading aid 2 with a transport frame 15, which forms several shelf compartments arranged above one another and next to one another for receiving load carriers 3. The load carriers 3 can be moved out of or into the respective shelf compartment by pulling on a first access side and/or by pushing from a second access side. Furthermore, the shelve compartments can each have a storage space or several storage spaces arranged one behind the other, on each of which a load carrier 3 can be placed.

The transport loading aid 2 can have transport wheels 17 mounted on the transport frame 15 as shown in FIG. 5c. However, as an alternative to the transport wheels 17, uprights 16 can also be provided, as is the case with the transport loading aid 2 shown in FIG. 5a.

FIG. 5d shows a transport loading aid 2 configured as a pallet, on which the load carriers 3 are arranged in a stacked manner. The load carriers 3 can be configured as described above in relation to FIG. 4a to FIG. 4c or comprise cardboard boxes as shown in FIG. 5d.

To transport the pallet using a driverless transport vehicle 18, the former can further be received on a transport loading aid 2, which is configured as described in relation to FIG. 5a and FIG. 5b, for example.

FIG. 6 shows a driverless transport vehicle 18 of a transport system, by means of which transport loading aids 2 can be transported. The transport vehicle 18 comprises a loading platform 19 for receiving a transport loading aid 2. Such a transport vehicle 18 is described in WO 2021/142498 A1, for example, in particular on pages 52 and 53.

In order to transport the transport loading aids 2 described above, the transport vehicle 18 can travel below the transport frame 15 and the loading platform 19 can be placed into contact with the transport frame 15, in particular from below. The loading platform 19 can be configured to be vertically movable, in particular orthogonally to its contact surface, for this purpose

A method 100 for transferring 160 articles between load carriers 3 can be executed particularly efficiently using the workstation 1 described. Such a method 100 is schematically depicted in FIG. 7. FIG. 8a and FIG. 8b show a transfer 160 of an article according to two consecutive transfer instructions.

In the method 100, transfer orders are initially acquired 110. Several transfer orders, for example picking orders, are acquired by the control computer of the control system 5 in this case.

For example, four transfer orders can be acquired, wherein a first transfer order comprises two pieces of a first article type (e.g. bananas) and three pieces of a second article type (e.g. salami), a second transfer order comprises one piece of the first article type and two pieces of the second article type, a third transfer order comprises three pieces of the first article type and one piece of the second article type, and a fourth transfer order comprises four pieces of the first article type.

In a next step, transport loading aids 2 are provided 120 at the workstation 1. On the one hand, transport loading aids 2 comprising first load carriers 3 are transported to the workstation 1 in this case. The first load carriers 3 contain the article comprised by the transfer orders. The first load carriers 3 are typically storage load carriers. On the other hand, transport loading aids 2 comprising further load carriers 3 are transported to the workstation 1. The further load carriers 3 can be assigned to the transfer orders, for example, as the further load carriers 3 are empty or pre-picked and/or can be used for article delivery to customers. The further load carriers 3 are assigned to the transfer orders before, during or after providing 120 the transport loading aids 2.

In addition, generating 130 a transfer instruction for the first article type comprised by the acquired transfer orders takes place in a further step. On the one hand, the transfer instruction specifies a number of articles to be transferred, i.e. which article type and how many pieces thereof are to be transferred. On the other hand, the transfer instruction specifies into which further load carriers 3 and at what respective number the article is to be placed into these.

In the example given above, the transfer instruction can thus specify that ten pieces of the first article type (bananas) are to be removed from the first load carrier 3 and two, one, three and four pieces are to be placed into the further load carriers 3 assigned to the transfer orders in accordance with the transfer orders.

The transfer instruction can optionally also specify a sequence direction LR, in which the further load carriers 3 assigned to the transfer orders are arranged in sequence, in particular starting from the first load carrier. The sequence direction is indicated by an arrow in FIG. 8a and FIG. 8b.

A further load carrier 3 last in the sequence direction LR can be defined as a last load carrier 3, into which an article is placed last according to the transfer instruction. The transfer operator U therefore comes to a stop in the region of the last load carrier 3, as is indicated by dashed lines in FIG. 8a and FIG. 8b.

Those load carriers 3 required for the transfer instruction are aligned 140 in a further step. In this case, the transport loading aids 2, which comprise the first load carrier 3 and the further load carriers 3, are lifted or lowered by the respective lifting device 4 such that the load carriers 3 required for the transfer instruction are aligned with the delivery plane AE.

Subsequently, the load carriers 3 can be provided 150 at the delivery positions AP as shown in FIG. 8a for a first transfer instruction and FIG. 8b for a further transfer instruction. The first and the further load carriers 3 can be moved to the respective delivery position in this case.

This can be executed manually by the transfer operator U or automatically by the delivery device 10 described above. In FIG. 8a and FIG. 8b, the first load carrier 3 is respectively provided at a delivery position AP on the left side of the work zone AB, and the further load carriers 3 are respectively provided at a delivery position AP on the right side of the work zone AB.

The article can then be transferred 160 by the transfer operator U. In this case, the transfer operator U removes a number of articles of the first article type specified by the transfer instruction, for example ten bananas, from the first load carrier 3. This can be displayed by the input/output unit 13 to the transfer operator U at that delivery position AP, at which the first load carrier 3 is provided. The completed removal of the article can be confirmed by the transfer operator U using the input/output unit 13.

Subsequently, the removed article can be transferred to the further load carriers 3 provided in accordance with the transfer instruction. The number of the articles to be placed into the respective further load carrier 3 can be displayed by the input/output unit 13 at the respective delivery position AP. The placement of the article into the further load carriers 3 can also be confirmed by the transfer operator U using the input/output unit 13.

After the article to be transferred has been transferred to the respective further load carriers 3, the corresponding further load carriers 3 can be moved back from the delivery position AP into the transport loading aids 2. This can be executed manually by the transfer operator U or automatically by the delivery device 10 described above.

Should all pieces of the article to be transferred according to the transfer instruction have been placed into further load carriers 3, the transfer operator U comes to a stop in the region of a last load carrier 3 as specified by a transfer operator U depicted by dashed lines in FIG. 8a.

A further transfer instruction is generated 130 in a further step. This can be executed as described previously and after transfer 160 has been performed or prior thereto, for example simultaneously with the generation 130 of the first transfer instruction described above. The further transfer instruction then pertains to a further article type of the acquired transfer orders.

In the example described above, the further transfer instruction can be generated, for instance, for the second article type (e.g. salami). The transfer instruction can thus specify that six pieces of the second article type (salami) are to be removed from the first load carrier 3 and three, two, one pieces are to be placed into the further load carriers 3 assigned to the transfer orders in accordance with the transfer orders. In this example, the fourth transfer order does not comprise a second article type, which is why only three further load carriers 3 are required, as is shown in FIG. 8b.

As can be seen from a combination of FIG. 8a and FIG. 8b, the further transfer instruction is preferably generated such that the corresponding article type is available at a provisioning position BP opposite the last load carrier 3. Aligning 140, providing 150 and transferring 160 according to the further transfer instruction can take place as described above for the transfer instruction.

FIG. 9 shows a picking system 20 in schematic plan view. The picking system 20 comprises a storage zone LB and a picking zone KB. The dashed line represents an imagined partitioning line between the storage zone LB and the picking zone KB in this case. However, these zones need not necessarily be adjacent to one another. For example, a movement zone could be provided between the storage zone LB and the picking zone KB.

As can be seen in FIG. 9, a plurality of transport loading aids 2 with load carriers 3 are arranged in the storage zone LB. Some of the load carriers 3 contain an article in this case and are used to store the article in the storage zone LB. In the same way, several transport loading aids 2 with empty load carriers 3, with pre-picked load carriers 3 and/or with picked load carriers 3 can be temporarily stored in the storage zone LB.

In the picking zone KB, several workstations 1 previously described are arranged, at which an article can be transferred between load carriers 3 as described above and thus prepared for delivery to customers.

In order to transport the transport loading aids 2 between the storage zone LB and the picking zone KB, the picking system 20 further comprises a transport system, which preferably has a plurality of transport vehicles 18 as shown in FIG. 9. The transport loading aids 2 and/or the transport vehicles 18 can be configured as described above.

The picking system 20 can thus be used to execute the method 100 described above, wherein the transport loading aids 2 are transported from the storage zone LB to the workstation 1 when provided 120, for example.

Finally, it is stated that the devices shown can, in reality, also comprise more or even fewer components than those shown. In some cases, the devices shown or their components have not been shown to scale and/or enlarged and/or shrunk.

List of reference numerals

| | |
|---|---|
| 1 | Workstation |
| 2 | Transport loading aid |
| 3 | Load carrier |
| 3.1 | Receiving compartment |
| 3.2 | Outer part |
| 3.3 | Inner part |
| 3.4 | Base |
| 4 | Lifting device |
| 4.1 | Support structure |
| 4.2 | Lifting platform |
| 5 | Control system |
| 6 | Side wall |
| 7 | Delivery opening |
| 8 | Work surface |
| 9 | Work platform |
| 10 | Delivery device |
| 11 | Push element |
| 12 | Door |
| 13 | Input/output unit |
| 14 | Bag |
| 15 | Transport frame |
| 16 | Upright |
| 17 | Transport wheel |
| 18 | Transport vehicle |
| 19 | Loading platform |
| 20 | Picking system |
| 100 | Method |
| 110 | Acquiring |
| 120 | Providing |
| 130 | Generating |
| 140 | Aligning |
| 150 | Providing |
| 160 | Transferring |
| AB | Work zone |
| AE | Delivery plane |
| AP | Delivery position |
| BP | Provisioning position |
| KB | Picking zone |
| LB | Storage zone |
| LR | Sequence direction |
| U | Transfer operator |
| VE | Vertical plane |

1. A workstation (1) for transferring articles between load carriers (3), which are arranged above one another and received by mobile transport loading aids (2), comprising
a control computer for acquiring transfer orders, each of which comprising one or more articles and being assigned to a load carrier (3),
a work zone (AB) delimited by a first and second vertical plane (VE) in a width direction, the vertical planes (VE) extending in a longitudinal direction,
a delivery plane (AE) intersecting the vertical planes (VE), in which several delivery positions (AP) for load carriers (3) are arranged adjoining the vertical planes (VE) and positioned at least partially in the work zone (AB),
several provisioning positions (BP) for mobile transport loading aids (2), which are arranged next to one another on a side of the first and/or second vertical plane (VE) facing away from the work zone (AB),
wherein at least one delivery position (AP) is assigned to each provisioning position (BP), and each provisioning position (BP) comprises a lifting device (4) for vertically moving the transport loading aid (2) at the respective provisioning position (BP) in order to align load carriers (3) with the delivery plane (AE), such that the load carriers (3) can be moved from the transport loading aids (2) to the at least one delivery position (AP) assigned to the respective provisioning position (BP),
wherein
the control computer is configured to generate a transfer instruction, which specifies an article type of an article to be transferred of at least one transfer order, a number of the articles to be transferred, a first load carrier (3) containing the article to be transferred and one or more further load carriers (3) assigned to the at least one transfer order, and
the workstation (1) comprises a control device, which is configured to actuate the lifting devices (4) such that those transport loading aids (2), from which the load carriers (3) specified by the transfer instruction are received, in particular one or more first load carriers (3) and/or one or more further load carriers (3), are moved vertically so as to align the load carriers (3), in particular with their respective base (3.4), with the delivery plane (AE).

2. The workstation (1) according to claim 1, further comprising first and second side wall (6), wherein a side of the first side wall (6) directed toward the work zone (AB) lies in the first vertical plane (VE) and a side of the second side wall (6) directed toward the work zone (AB) lies in the second vertical plane (VE), such that the work zone (AB) is delimited by the side walls (6) in a width direction.

3. The workstation (1) according to claim 2, wherein the side walls (6) each have at least one delivery opening (7), which extends in a longitudinal direction over one or more delivery positions (AP), such that each delivery position (AP) is assigned a delivery opening (7).

4. The workstation (1) according to claim 3, wherein the delivery openings (7) each have a door (12), which, in particular, can be opened automatically.

5. The workstation (1) according to claim 1, wherein a delivery device (10) for moving a load carrier (3), in particular for individually moving several load carriers (3) arranged next to one another, from the respective transport loading aid (2) to a delivery position (AP), is arranged at each case at the provisioning positions (BP).

6. The workstation (1) according to claim 1, wherein one or more work surfaces (8) are respectively arranged along the first vertical plane (VE) and/or along the second vertical plane (VE), wherein the work surfaces (8) lie in the delivery plane (AE) and have the delivery positions (AP) arranged on the delivery plane (AE).

7. The workstation (1) according to claim 1, wherein a walkable work platform (9) is arranged in the work zone (AB), wherein a vertical distance between the work platform (9) and the delivery plane (AE) is preferably variable.

8. The workstation (1) according to claim 1, wherein a robot, which can be moved along a longitudinal direction for transferring the article between load carriers (3) provided at the delivery positions (AP), is arranged in the work zone (AB).

9. The workstation (1) according to claim 1, further comprising at least one input/output unit (13), which is configured to display the number of the articles to be transferred specified by the transfer instruction, and/or to display a number of articles and to be placed into the load carriers (3) assigned to the at least one transfer order, and/or to receive a confirmation command.

10. The workstation (1) according to claim 1, wherein each provisioning position (BP) comprises a lifting device (4) arranged to be stationary for vertically moving the transport loading aid (2).

11. The workstation (1) according to claim 10, wherein the stationary lifting device (4) comprises a vertically extending support structure (4.1) and a lifting platform (4.2) adjustably mounted on the lifting platform (4.2) via a lifting drive, wherein the transport loading aid (2), from which the load carrier or the load carriers (3) specified by the transfer instruction is/are received, can be placed on the lifting platform.

12. A workstation (1) for transferring articles between load carriers (3), which are arranged above one another and received by mobile transport loading aids (2), comprising
a work zone (AB) delimited by a first and second vertical plane (VE) in a width direction, the vertical planes (VE) extending in a longitudinal direction,
a delivery plane (AE) intersecting the vertical planes (VE), in which several delivery positions (AP) for load carriers (3) are arranged adjoining the vertical planes (VE) and positioned at least partially in the work zone (AB),
several provisioning positions (BP) for mobile transport loading aids (2), which are arranged next to one another on a side of the first and/or second vertical plane (VE) facing away from the work zone (AB),
wherein at least one delivery position (AP) is assigned to each provisioning position (BP), and each provisioning position (BP) comprises a lifting device (4) for vertically moving the transport loading aid (2) at the respective provisioning position (BP) in order to align load carriers (3) with the delivery plane (AE), such that the load carriers (3) can be moved from the transport loading aids (2) to the at least one delivery position (AP) assigned to the respective provisioning position (BP),
wherein
each provisioning position (BP) comprises a stationary lifting device (4) for vertically moving the transport loading aid (2), wherein the stationary lifting device (4) comprises a vertically extending support structure (4.1) and a lifting platform (4.2) adjustably mounted on the lifting platform (4.2) via a lifting, wherein the transport loading aid (2) can be placed on the lifting platform, and
the workstation (1) additionally comprises a control device, which is configured to actuate the lifting platforms (4.2) of the lifting devices (4) such that the transport loading aids (2) are individually moved vertically to such an extent that the load carriers (3), in particular with their respective base (3.4), are aligned with the delivery plane (AE).

13. The workstation (1) according to claim 12, further comprising a control computer for acquiring transfer orders, each of which comprises one or more articles and is assigned to a load carrier (3),
wherein the control computer is configured to generate a transfer instruction, which specifies an article type of an article to be transferred of at least one transfer order, a number of the articles to be transferred, a first load carrier (3) containing the article to be transferred and one or more further load carriers (3) assigned to the at least one transfer order, and
wherein the control device is configured to actuate the lifting platforms (4.2) of the lifting devices (4) such that those transport loading aids (2), from which the load carriers (3) specified by the transfer instruction are received, in particular one or more first load carriers (3) and/or one or more further load carriers (3), are individually moved vertically to such an extent that the load carriers (3) required for the transfer instruction, in particular with their respective base (3.4), are aligned with the delivery plane (AE).

14. A picking system (20) comprising a storage zone (LB), a picking zone (KB), transport loading aids (2) arranged in the storage zone (LB), at least one workstation (1) and a transport system, by means of which the transport loading aids (2) can be transported between the storage zone (LB) and the picking zone (KB) and can be provided at the at least one workstation (1), wherein the at least one workstation (1) is configured according to claim 1.

15. The picking system (20) according to claim 14, wherein the transport system comprises a plurality of driverless transport vehicles (18).

16. The picking system (18) according to claim 14, wherein several load carriers (3) with articles of differing article types are received by some of the transport loading aids (2) respectively.

17. The picking system (18) according to claim 14, further comprising a warehouse management system and a transport system control unit, the warehouse management system being configured to acquire several transfer orders for a defined time window and to generate a transport order based on the acquired transfer orders, wherein the transport order specifies the transport loading aids (2) required for the transfer orders and provisioning positions assigned to the transport loading aids (2) of the at least one workstation (1), and the transport system control unit is configured to receive the transport order from the warehouse management system and to actuate the transport system such that transport loading aids (2) are transported from the storage zone (LB) to the assigned provisioning position (BP) according to the transport order.

18. A method (100) for transferring articles according to transfer orders using a workstation (1) according to claim 1 and/or using a picking system (18) comprising the workstation (1) according to claim 1, comprising the steps:
i) acquiring (110) transfer orders by the control computer of the workstation (1), the transfer orders each comprising a number of articles,
ii) providing (120) transport loading aids (2) with load carriers (3), which contain the articles of the transfer orders, and transport loading aids (2) with load carriers (3), which are respectively assigned to at least one transfer order using the control computer,
iii) generating (130) a transfer instruction using the control computer, which specifies an article of the same article type to be transferred of at least one transfer order, a first load carrier (3) containing the article to be transferred and at least one further load carrier (3) assigned to the at least one transfer order,
iv) aligning (140) the first and the at least one further load carrier (3) with the delivery plane (AE) using the lifting devices (4),
v) providing (150) load carriers (3), the first load carrier (3) specified by the transfer instruction and at least one further load carrier (3) being moved from the transport loading aid (2) to the respectively assigned delivery position (AP),
vi) transferring (160) the article according to the transfer instruction, the article to be transferred being removed from the first load carrier (3) at the respective delivery position (AP) and, in particular successively, being placed into the at least one further load carrier (3),
vii) generating (130) a further transfer instruction using the control computer, which specifies an article of the same article type to be transferred of at least one transfer order, a first load carrier (3) containing the article to be transferred and at least one further load carrier (3) assigned to the at least one transfer order,
viii) repeating the steps iv) to vi) for the further transfer instruction.

19. The method (100) according to claim 18, wherein in the step iii), a further load carrier (3) is determined as the last load carrier (3), into which an article is placed last in the step vi).

20. The method (100) according to claim 18, wherein the transfer instruction generated in the step iii) comprises a sequence direction (LR), along which the further load carriers (3) are arranged, wherein that further load carrier (3) which is arranged last in the sequence direction (LR) is determined as the last load carrier (3), and in the step vi) articles, in particular several pieces of the article, are successively placed into the further load carriers (3) provided along the sequence direction (LR), wherein an article is last placed into the last load carrier (3).

21. The method (100) according to claim 19, wherein the further transfer instruction in the step vii) is generated such that the transfer instruction comprises that article of the same article type that is contained in a load carrier (3) present in a provisioning position (BP) opposite the last load carrier (3).

22. The method (100) according to claim 18, wherein the workstation (1) further comprises first and second side wall (6), wherein a side of the first side wall (6) directed toward the work zone (AB) lies in the first vertical plane (VE) and a side of the second side wall (6) directed toward the work zone (AB) lies in the second vertical plane (VE), such that the work zone (AB) is delimited by the side walls (6) in a width direction, wherein the side walls (6) each have at least one delivery opening (7), which extends in a longitudinal direction over one or more delivery positions (AP), such that each delivery position (AP) is assigned a delivery opening (7), wherein the delivery openings (7) each have a door (12), which, in particular, can be opened automatically, and wherein in the step v), doors (12) of those delivery openings (7) are opened, with which the load carriers (3) specified by the transfer instruction are aligned.

23. The method (100) according to claim 18, wherein the workstation (1) is configured to have a delivery device (10) for moving a load carrier (3), in particular for individually moving several load carriers (3) arranged next to one another, from the respective transport loading aid (2) to a delivery position (AP), arranged at each case at the provisioning positions (BP), and the load carriers (3) specified in the step v) are moved from the transport loading aid (2) to a delivery position (AP) using the respective delivery device (10).

24. The method (100) according to claim 18, wherein the transport loading aids (2) are stored in a storage zone (LB), in particular in a storage zone (LB) of a picking system (18) comprising the storage zone (LB), a picking zone (KB), the transport loading aids (2) arranged in the storage zone (LB), at least one workstation (1) and a transport system, by means of which the transport loading aids (2) can be transported between the storage zone (LB) and the picking zone (KB) and can be provided at the at least one workstation (1), and in the step ii) are transported from the storage zone (LB) to the workstation (1) using a transport system, in particular by driverless transport vehicles (18).

25. The method (100) for transferring articles according to transfer orders using a workstation (1) according to claim 12, comprising the steps:
i) acquiring (110) transfer orders by a control computer, the transfer orders each comprising a number of articles,
ii) providing (120) mobile transport loading aids (2) comprising a mobile first transport loading aid (2) with first load carriers (3), which contain the articles of the transfer orders, and a mobile second transport loading aid (2) with further load carriers (3), which are respectively assigned to at least one transfer order using the control computer,
iii) generating (130) a transfer instruction using the control computer, which specifies an article to be transferred of at least one transfer order, a first load carrier (3) containing the article to be transferred and/or one further load carrier (3) assigned to the at least one transfer order,
iv) receiving the mobile first transport loading aid (2) with the first load carriers (3) on a first lifting device (4) of the lifting devices (4), and receiving the mobile second transport loading aid (2) with the further load carriers (3) on a second lifting device (4) of the lifting devices (4),
v) aligning (140) the first load carrier (3) by vertically moving the mobile first transport loading aid (2) using the lifting platform (4.2) of the first lifting device (4), and aligning (140) the further load carrier (3) by vertically moving the mobile second transport loading aid (2) using the lifting platform (4.2) of the second lifting device (4), in each case with the delivery plane (AE),
vi) providing (150) the first load carrier (3) by moving the first load carrier (3) aligned with the delivery plane (AE) to the assigned delivery position (AP), and providing (150) the further load carrier (3) by moving the further load carrier (3) aligned with the delivery plane (AE) to the assigned delivery position (AP),
vi) transferring (160) the article according to the transfer instruction, the article to be transferred being removed from the first load carrier (3) provided at the delivery position (AP) and, in particular successively, being placed into the further load carrier (3) provided at the delivery position (AP).
